(19) United States
(12) Patent Application Publication
(10) Pub. No.: US 2016/0000125 A1
(43) Pub. Date: Jan. 7, 2016

(54) FLOW AGENT METHODS AND PRODUCTS

(71) Applicant: OCEAN SPRAY CRANBERRIES, INC., Lakeville-Middleboro, MA (US)

(72) Inventor: Soumya Roy, Lakeville-Middleboro, MA (US)

(21) Appl. No.: 14/769,952

(22) PCT Filed: Mar. 13, 2014
(86) PCT No.: PCT/US14/25744

§ 371 Date: Aug. 24, 2015

Related U.S. Application Data
(60) Provisional application No. 61/783,800, filed on Mar. 14, 2013.

(51) Int. Cl. A23L 1/212; A23L 1/00

(52) U.S. Cl. CPC A23L 1/2125; A23L 1/0038; A23V 2002/00

(57) ABSTRACT

The present specification provides a non-sticky, free-flowing solid comestible, which is typically sticky, by coating it with a flow agent. Methods of preparing the flow agent and a food body substantially coated with the flow agent are also described.

### CROSS REFERENCE TO RELATED APPLICATIONS

This application claims priority to U.S. Patent Application Ser. No. 61/783,800, filed Mar. 14, 2013, the disclosure of which is incorporated herein by reference in its entirety.

### TECHNICAL FIELD

This invention relates to products, e.g., a food body, with improved handling properties created by coating the food body with a flow agent produced from skin, hull, seeds, or any combination thereof, of fruits, and/or vegetables.

### BACKGROUND

Discovery of health benefits of fruits and vegetables has resulted in increased consumer interest in consuming more fruits and vegetables. Dried fruits and vegetables, particularly sweetened or candied versions, have gained popularity as snacks as well as ingredients in other food products, e.g., trail mix and cereal. Although dried fruits and vegetables generally have water activities below about 0.50, consumers often prefer them with higher water activities for improved taste qualities. Unfortunately, products with a water activity above about 0.50 often stick to themselves (i.e., cohesion) and to processing equipment (i.e., adhesion), making further processing such as dicing, packaging, and mixing, difficult. Further, use of water as a flow agent for dried fruits and vegetables encourages mold growth. A need exists for useful flow agents.

### SUMMARY

The present disclosure is based, at least in part, on the discovery that coating a food body with particles of skin, hull, seeds, or any combination thereof, of fruits, and/or vegetables provides a food body that has improved flowability, i.e., less cohesion to other food bodies and less adhesion to processing equipment. In particular, applicants have found that coating food bodies, e.g., cranberries, with a flow agent produced from, e.g., skin, hull, seeds, or any combination thereof, of fruits, and/or vegetables, e.g., cranberry skin or hull, allows the food bodies to flow more freely. Accordingly, the present specification provides, e.g., a flow agent comprising particles of skin, hull, seeds, or any combination thereof, of fruits, and/or vegetables. In some embodiments, the particles are on average less than one millimeter in size, e.g., particles that range in size from about 70 micrometers to about 900 micrometers in size, e.g., particles that are on average about 250 micrometers in size. In one embodiment, the particles have a moisture content of about or less than 10%, e.g., about 3% to about 5%.

In another aspect, the present disclosure provides methods of providing a food body substantially coated with a flow agent. The methods include providing a food body, e.g., a fruit body or vegetable body, and applying a flow agent as described herein to substantially coat the food body. In some instances, the flow agent comprises particles that are on average less than one millimeter in size, e.g., particles that range in size from about 70 micrometers to about 900 micrometers in size, e.g., particles that are on average about 250 micrometers in size. In one embodiment, the particles have a moisture content of about or less than 10%, e.g., about 3% to about 5%. In one embodiment, the flow agent accounts for about 0.1% to about 2% of the total food body by weight, e.g., the flow agent accounts for about 0.25% to about 1% of the total food body by weight. In some embodiments, the flow agent is produced from the same food as the food body. In some embodiments, the flow agent is produced from a different food than the food body. In some embodiments, the food body is a cranberry, dried cranberry, or a raisin. In some embodiments, the flow agent is produced from a cranberry, e.g., cranberry presscake powder. In some embodiments, the methods include packaging the food body substantially coated with a flow agent in a container, e.g., a bag, box, jar, or bottle.

In yet another aspect, the present disclosure features products comprising a food body, e.g., a fruit body or a vegetable body, substantially coated with a flow agent comprising particles of skin, hull, seeds, or any combination thereof, of fruits, and/or vegetables that are on average less than one millimeter in size and have a moisture content of about or less than 10%, e.g., about 3% to about 5%, and wherein the flow agent accounts for about 0.1% to about 2% of the total food body by weight, e.g., about 0.25% to about 1% of the total food body by weight. In some embodiments, the food body, e.g., a cranberry, dried cranberry, or raisin, is substantially coated with a flow agent comprising particles that range in size from about 70 micrometers to about 900 micrometers in size, e.g., particles that are on average about 250 micrometers in size. In one embodiment, the flow agent is produced from the same food as the food body. In some embodiments, the flow agent is produced from a different food than the food body.

In some instances, the food body can be a fruit body. The fruit body can be, e.g., a fruit selected from the group consisting of cranberry, blueberry, cherry, grape, mango, pineapple, raspberry, blackberry, date, apple, apricot, lingonberry, tomato, huckleberry, chokeberry, fig, gooseberry, elderberry, plum, prune, pear, and peach, among others. In other instances, the food body can be a vegetable body. The vegetable body can be, e.g., a vegetable selected from the group consisting of a mushroom, celery, pepper, carrot, potato, cucumber, corn, onion, pea, and squash, among others. An exemplary food body is a dried cranberry or raisin. The terms “fruit body” and “vegetable body” are examples of food bodies.

As used herein, the term “flow agent” refers to particles of dried, milled skin, hull, seed, or any combination thereof of a fruit and/or vegetable. A fruit or vegetable hull is the dry outer covering of a fruit or vegetable, is well-known in the art, and described herein. An exemplary flow agent is produced from a cranberry hull that has been subjected to an extraction process (e.g., squeezing and/or countercurrent extraction) prior to being treated with the presently-described process. As described herein, fruit or vegetable hulls can be pressed to make a presscake, dried, and milled to produce particles of a flow agent.

In some embodiments, the flow agent is produced from a fruit, e.g., a fruit selected from the group consisting of cranberry, grape, blueberry, cherry, mango, pineapple, raspberry, blackberry, date, apple, apricot, lingonberry, tomato, huckleberry, chokeberry, fig, gooseberry, elderberry, plum, prune, pear, and peach, or any combination of these or other fruits. In one embodiment, the flow agent is cranberry presscake powder.

In some instances, the flow agent is produced from a vegetable. The vegetable can be, e.g., a vegetable selected from the group consisting of a mushroom, celery, pepper, carrot, potato, cucumber, corn, onion, pea, and squash, or any combination of these or other vegetables.

Unless otherwise defined, all technical terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, and other references mentioned herein are incorporated by reference in their entirety. In case of conflict, the present specification, including definitions, will control.

Other features and advantages of the invention will be apparent from the following detailed description and figures, and from the claims.

### DESCRIPTION OF DRAWINGS

FIG. 1 is a line graph illustrating the size distribution of dried, milled presscake produced from cranberries. 20 mesh size=0.841 millimeters. 60 mesh size=0.25 millimeters. 100 mesh size=0.149 millimeters. 200 mesh size=0.074 millimeters.

FIG. 2 is a table of test results comparing stickiness of sweetened dried cranberries coated with various flow agents, including presscake powder produced from cranberries, starch, rice bran fiber, tri-calcium phosphate, and calcium silicate.

FIG. 3 is a is a table of test results comparing stickiness of sweetened dried cranberries coated with various flow agents, including presscake powder produced from cranberries, starch, rice bran fiber, tri-calcium phosphate, and calcium silicate at 0.1%, 0.25%, and 0.5% (w/w). FIG. 4 is a line graph showing moisture sorption isotherms at 20° C. with moisture content of corn starch and presscake powder as a function of water activity.

### DETAILED DESCRIPTION

The present disclosure describes useful flow agents, which can be used to produce improved dried fruits and vegetables, also referred to herein as “food bodies,” with lower cohesion and adhesion properties. Such food bodies may demonstrate less stickiness to processing equipment such as dicing blades, conveyors, and fillers. Lower cohesion and adhesion properties for the food bodies are achieved by coating the surface of the food body, with a flow agent. The flow agent can include particles of fruit and/or vegetable skin, hull, seeds, or any combination thereof. Particularly useful are dried and milled presscake, e.g., dried and milled skin, hull, seeds, or any combination thereof, of fruits, and/or vegetables.

Expression of juice from fruits such as cranberry, grape, and blueberry results in pressed skin, hulls, and seeds as a byproduct. These byproducts are rich in fiber and omega-3 fatty acids. This byproduct, often referred to as presscake or pomace, is suitable for processing and use as a flow agent in accordance with the present invention due to its low hygroscopic property and high glass transition temperature (Tg) at low moisture content. Flow agents produced from cranberry presscake and methods of treating cranberries with such flow agents will be described herein, although skilled practitioners will appreciate that the flow agents and methods may be modified to involve other types of fruit such as grapes, blueberries, or blackberries.

A flow agent made from a vegetable or fruit such as cranberries, grapes, or blueberries are all natural and can be used to coat the same type of fruit or vegetable from which the flow agent is made. In some embodiments, a food body can be substantially coated with a flow agent produced from the same type of fruit or vegetable without changing the taste and/or visual qualities of the food body. Skilled practitioners will appreciate that this allows manufacturers to provide a more favorable ingredient listing label for health conscious consumers. For example, industrial grade diced sweetened dried cranberries, typically sold to food manufacturers as an ingredient, can be coated with a flow agent produced from cranberry skin, hulls, seeds, or any combination thereof (e.g., presscake), without the manufacturer having to list additional ingredients on the label. This also eliminates the need to add additional ingredients that are typically used as flow agents, such as water, starch (see, U.S. Pat. No. 7,704,538), cellulose (see, US 2010/0104699), oil (see, U.S. Pat. No. 4,946,694), or fat (see, U.S. Pat. No. 6,616,956). Another particular advantage of the flow agents described herein is that they exhibit very little hysteresis and follow a Type III moisture sorption isotherm. Accordingly, the flow agents can be utilized at a higher moisture content than that of typical flow agents, e.g., corn starch, since fluctuations in water activity do not affect flow properties of the flow agents as much as its corn starch counterpart.

Alternatively, or in addition, food bodies can be substantially coated with a flow agent produced from a different food to give the food body a unique taste and/or visual quality. For example, a cranberry food body can be substantially coated with a flow agent produced from a grape, blueberry, cherry, mango, pineapple, raspberry, blackberry, date, apple, apricot, lingonberry, tomato, huckleberry, chokeberry, fig, gooseberry, elderberry, plum, prune, pear, or peach among others, or any combination of the forgoing.

### Flow Agent Formulations

Various flow agent formulations are described herein. Applicants have determined surprisingly that a food body substantially coated with a flow agent comprising particles of dried and milled skin, hull, seeds, or any combination thereof, of a fruit and/or vegetable demonstrates improved flowability, i.e., lower cohesion and/or adhesion to processing equipment. Flow agents can be produced from the skin, hulls, seeds, or any combination thereof, of fruits and/or vegetables, e.g., cranberries, after juice has been expressed from the fruit or vegetable. In some embodiments, fruits and/or vegetables are treated in an extraction process (e.g., squeezing and/or countercurrent extraction) to produce skin, hulls, and seeds and then pressed to produce a presscake. Alternatively or in addition, pomace can be used to produce a flow agent, whereby enzymes, e.g., pectinase, are added to fruits and vegetables prior to pressing the fruit or vegetable to express juice. Skilled practitioners will understand that a flow agent can be produced from fruit and/or vegetable skin, hull, seed, presscake, pomace, or any combination thereof.

In an exemplary method, the skin, hulls, seeds, or any combination thereof, of fruit or skin and/or hulls of vegetables can be dried and milled into particles that are on average less than one millimeter in size and have a moisture content of about or less than 10%. For example, a presscake comprising the skin, hulls, seeds, or any combination thereof, of fruits and/or skin and/or hulls of vegetables can be dried by fluidized drying or drum drying to remove moisture from the presscake. Skilled practitioners will appreciate that other methods can be used to remove moisture from the presscake by forcing air over the presscake and allowing the moisture to evaporate. In an exemplary method, the presscake is dried in a GLATT™ Model 60 batch fluid bed dryer (Ramsey, N.J.), and warm air, e.g., air at or at about 65° C., 70° C., 75° C., 80° C., 85° C., 90° C., 95° C., 100° C., is used to heat and dry the presscake to a moisture content of about or less than 10%, e.g., about 0.5%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, or about 9.5%. Skilled practitioners will appreciate that the procedure can be modified to provide any useful moisture content.

Following drying, the presscake can be milled into particles that are on average greater than zero millimeter and less than or about one millimeter in size, e.g., less than or about 0.9 millimeters, 0.8 millimeters, 0.7 millimeters, 0.6 millimeters, 0.5 millimeters, 0.4 millimeters, 0.3 millimeters, 0.2 millimeters, or less than or about 0.1 millimeters in size. The minimum size can be, for example, one micrometer, two micrometers, three micrometers, four micrometers, five micrometers, six micrometers, seven micrometers, eight micrometers, nine micrometers, or ten micrometers. For example, the flow agent can have particles of a presscake that range in size from, inclusively, about 70 micrometers to about 900 micrometers, e.g., from about 74 micrometers to about 841 micrometers, from about 80 micrometers to about 800 micrometers, from about 85 micrometers to about 750 micrometers, from about 90 micrometers to about 700 micrometers, from about 95 micrometers to about 650 micrometers, from about 100 micrometers to about 600 micrometers, from about 110 micrometers to about 550 micrometers, from about 120 micrometers to about 500 micrometers, from about 130 micrometers to about 450 micrometers, from about 140 micrometers to about 400 micrometers, from about 150 micrometers to about 350 micrometers, from about 200 micrometers to about 300 micrometers, from about 220 micrometers to about 280 micrometers, from about 240 micrometers to about 260 micrometers, or from about 245 micrometers to about 255 micrometers. In some instances, the flow agent can include particles of a presscake that are on average about 200 micrometers, about 210 micrometers, about 220 micrometers, about 230 micrometers, about 240 micrometers, about 250 micrometers, about 260 micrometers, about 270 micrometers, about 280 micrometers, about 290 micrometers, or about 300 micrometers.

Milling can be performed using any art known process, e.g., by slicing, chopping, dicing, or cutting the skin, hulls, seeds, or any combination thereof, of a fruit and/or vegetable into a relatively fine, granular material. In an exemplary method, the skin, hulls, seeds, or any combination thereof, of a fruit and/or vegetable can be milled with a FITZPATRICK® Model D6 hammermill (Elmhurst, Ill.). Skilled practitioners will appreciate that other methods can be used to mill the skin, hulls, seeds, or any combination thereof, of a fruit and/or vegetable into a fine powder. If desired, the resultant fine powder can be filtered with mesh screen to obtain particles with the desired size. For example, particles passing through a 0020 screen are on average approximately 250 micrometers in size, which would result in one embodiment of a flow agent useful in the present invention.

After the skin, hulls, seeds, or any combination thereof, of a fruit and/or vegetable has been milled into the desired size particles, the moisture content of the flow agent typically increases slightly over the moisture content of the dried skin, hulls, seeds, or any combination thereof, of a fruit and/or vegetable. For example, the flow agent can have a moisture content of about or less than 10%, e.g., about or less than 9.5%, 9%, 8.5%, 8%, 7.5%, 7%, 6.5%, 6%, 5.5%, 5%, 4.5%, 4%, 3.5%, 3%, 2.5%, 2%, 1.5%, or about or less than 1%, but greater than 0%. In some embodiments, the flow agent can have a moisture content of about 2%, about 2.5%, about 3%, about 3.5%, about 4%, about 4.5%, about 5%, about 5.5%, about 6%, about 6.5%, about 7%, about 7.5%, about 8%, about 8.5%, about 9%, or about 9.5%. Flow agents can have a moisture content of about 1% to about 10%, about 2% to about 9%, about 3% to about 8%, about 3% to about 5%, about 3.5% to about 8%, about 4% to about 7%, about 4.5% to about 7%, about 5% to about 7%, or about 5.5% to about 7%.

### Methods of Coating a Food Body

A food body can be treated with a flow agent using any method known in the art. In an exemplary method, food bodies, e.g., dried fruits and vegetables, e.g., dried cranberries, are substantially coated with a flow agent by mixing the food bodies with the flow agent in a tumbler or sprinkling and shaking the flow agent over the food bodies to coat greater than or about 50% of the surface area of the food body, e.g., greater than or about 55%, 60%, 65%, 70%, 75%, 80%, 85%, 90%, or greater than or about 95% of the surface area of the food body. Skilled practitioners will appreciate that the food bodies may not need to be covered entirely with flow agent in order to obtain at least some of the benefit of the flow agent, i.e., in some instances, a partial covering may suffice, e.g., a flow agent covering greater than or about 1% to less than or about 50% of the surface area of the food body, e.g., about 45%, 40%, 35%, 30%, 25%, 20%, 15%, 10%, or about 5% of the surface area of the food body. Optionally, after coating the food bodies with flow agent, the food bodies can be processed, e.g., passed through a screen, to remove excess flow agent. The food bodies can be coated with flow agent to account for about 0.1% to about 2% of the total weight of the food body, e.g., about 0.1% to about 1%, about 0.2% to about 0.8%, about 0.2% to about 0.7%, about 0.2% to about 0.5%, about 0.3% to about 5%, or about 0.4% to about 0.5% of the total weight of the food body.

The residence time of the food bodies in a tumbler can vary as necessary. Skilled practitioners will appreciate that increased residence times may allow for increased coverage of the food body with the flow agent. In some embodiments, the residence time is about one second to about 60 minutes, e.g., about one second to about 60 seconds, about two seconds to about 50 seconds, about five seconds to about 30 seconds, about 10 seconds to about 20 seconds, about 10 minutes to about 60 minutes, or about 20 minutes to about 55 minutes. In other embodiments, a residence time of greater than one hour, e.g., about one hour to about 12 hours may be used, e.g., about two hours to about three hours, e.g., about two hours, may be used, as can a residence time of about eight hours to about 10 hours.

Food bodies may be treated with flow agent at any useful temperature. The temperature at which the food body is coated with flow agent may be close to room temperature, e.g., about 60° F. to about 95° F. Skilled practitioners will appreciate that lower or higher temperatures may be used in certain situations. For example, the food body may be coated at lower temperatures, e.g., about 40° F. to about 60° F., or higher temperatures, e.g., about 120° F. to about 130° F.

### Products

The methods described herein can provide a number of products with improved flowability. The product typically includes a food body, e.g., a food component with natural and/or endogenous material of the food body, e.g., a fruit hull, such as a cranberry or grape hull or a vegetable hull, substantially coated with a flow agent as described herein. Any type of food body, e.g., a fruit or vegetable food body, is within the present invention. Exemplary fruit bodies include, but are not in any way limited to, cranberries, grapes, blueberries, cherries, mangos, pineapples, raspberries, blackberries, dates, apples, apricots, lingonberries, tomatoes, huckleberries, chokeberries, figs, gooseberries, elderberries, plums, prunes, pears, peaches, and the like. Exemplary vegetable bodies include, but are not limited to, mushrooms, celery, peppers, carrots, potatoes, cucumbers, corn, onions, peas, squash and the like.

Encompassed are products that include food bodies substantially coated with a flow agent produced from the same or different fruit or vegetable than the food body. For example, the products can include cranberries, e.g., dried cranberries, coated with a flow agent produced from cranberry, grape, or blueberry. In some embodiments, the cranberry food bodies are substantially coated with a flow agent produced from cranberry.

The food bodies can be coated with flow agent to account for about 0.1% to about 2% of the total food body by weight, e.g., about 0.1% to about 1%, about 0.2% to about 0.8%, about 0.2% to about 0.7%, about 0.2% to about 0.5%, about 0.3% to about 5%, about 0.4% to about 0.5% of the total food body by weight. As described herein, the flow agent can comprise particles that are on average greater than zero millimeter and less than one millimeter in size, e.g., less than 0.9 millimeters in size, less than 0.8 millimeters in size, less than 0.7 millimeters in size, less than 0.6 millimeters in size, less than 0.5 millimeters in size, less than 0.4 millimeters in size, less than 0.3 millimeters in size, less than 0.2 millimeters in size, or less than 0.1 millimeters in size. For example, in some embodiments, the flow agent has particles that range in size from about 70 micrometers to about 900 micrometers in size, from about 74 micrometers to about 841 micrometers in size, from about 80 micrometers to about 800 micrometers in size, from about 85 micrometers to about 750 micrometers in size, from about 90 micrometers to about 700 micrometers in size, from about 95 micrometers to about 650 micrometers in size, from about 100 micrometers to about 600 micrometers in size, from about 110 micrometers to about 550 micrometers in size, from about 120 micrometers to about 500 micrometers in size, from about 130 micrometers to about 450 micrometers in size, from about 140 micrometers to about 400 micrometers in size, from about 150 micrometers to about 350 micrometers in size, from about 200 micrometers to about 300 micrometers in size, from about 220 micrometers to about 280 micrometers in size, from about 240 micrometers to about 260 micrometers in size, or from about 245 micrometers to about 255 micrometers in size. In some instances, the flow agent has particles of a presscake that are on average about 200 micrometers in size, about 210 micrometers in size, about 220 micrometers in size, about 230 micrometers in size, about 240 micrometers in size, about 250 micrometers in size, about 260 micrometers in size, about 270 micrometers in size, about 280 micrometers in size, about 290 micrometers in size, or about 300 micrometers in size.

Also as described herein, the flow agent can have a moisture content of about or less than 10%, e.g., about or less than 9.5%, about or less than 9%, about or less than 8.5%, about or less than 8%, about or less than 7.5%, about or less than 7%, about or less than 6.5%, about or less than 6%, about or less than 5.5%, e.g., about or less than 5%, e.g., about or less than 4.5%, e.g., about or less than 4%, e.g., about or less than 3.5%, e.g., about or less than 3%, e.g., about or less than 2.5%, e.g., about or less than 2%, e.g., about or less than 1.5%, e.g., about or less than 1%, but greater than 0%. In some embodiments, the flow agent can have a moisture content of about 2%, about 2.5%, about 3%, about 3.5%, about 4%, about 4.5%, about 5%, about 5.5%, about 6%, about 6.5%, about 7%, about 7.5%, about 8%, about 8.%, about 9%, or about 9.5%. Flow agents can have a moisture content of about 1% to about 10%, about 2% to about 9%, about 3% to about 8%, about 3% to about 5%, about 3.5% to about 8%, about 4% to about 7%, about 4.5% to about 7%, about 5% to about 7%, or about 5.5% to about 7%.

### EXAMPLES

Several general exemplary formulations are described below, which may be used in any of the methods described herein and do not limit the scope of the invention described in the claims. All percentage values are provided on a weight/weight basis:

### Example 1

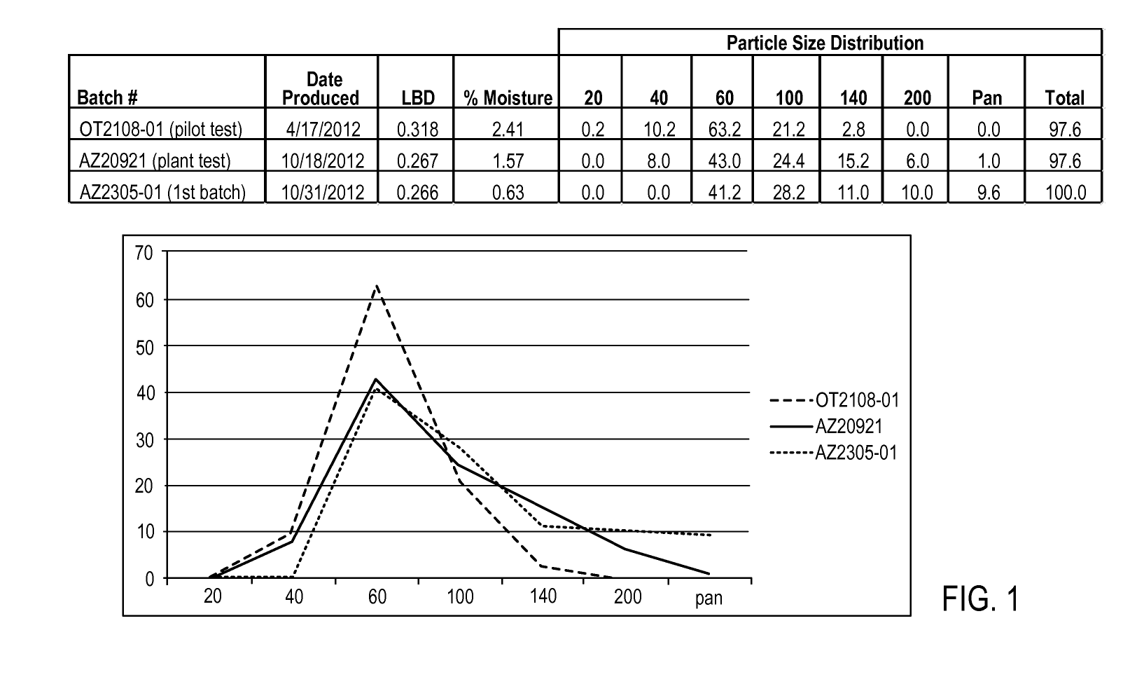

Frozen presscake weighing approximately 100 pounds was transferred to a stainless flat hopper and manually reduced the mass to 2 to 3 inch sized chunks. The frozen chunks were then transferred to a GLATT™ Model 60 batch fluid bed dryer and 85° C. air was used to heat the product up and dry the material from 70-75% moisture to less than 3% moisture in approximately three hours. After the presscake was dried, the cranberries looked like small flat reddish pink flakes. The 100 pound presscake yielded about 25-30 pounds of dry flakes. The flakes were then milled in a FITZPATRICK® Model D6 hammermill. The particle size distribution of the resultant fine powder coming thru the 0020 screen is shown in FIG. 1 (Lot AZ23051-01).

### Example 2

Cohesion properties were quantified by RO-TAP® and plant clumping test. The RO-TAP® sieve shaker are used for laboratory testing of particle size and size distribution in samples of solid materials. Testing is accomplished by stacking a set of sieves of various sizes on top of each other, where the larger-hole sieves are on top and smaller-hole sieves are at the bottom, in decreasing order. A solid pan is at the bottom to catch all sample particles that can pass through the smallest sieve's openings. The RO-TAP® sieve shaker is an apparatus that holds the entire stack of testing sieves, mechanically shaking/rotating them in a circular motion and tapping the top of the stack at the same time. These actions help the various sized particles to be able to move through the stack of sieves until they rest on a sieve whose openings are too small for them to pass through. After a designated period of time of this mechanical shaking/tapping, the screens are removed from the RO-TAP® sieve shaker, and each sieve's contents are weighed up and recorded individually. From this data set, the % retained on each sieve is used to classify the size fractions present in the sample. The plant clumping test involves compressing food bodies and measuring how they fall apart. One pound of force is applied to a 200 g sample of food bodies for one minute, and the food bodies are monitored to determine how long it takes for half of the food bodies to fall apart. If half of the food bodies fall apart in under one minute, the food bodies are classified as “not sticky.” If half of the food bodies fall apart in under 2.5 minutes, the food bodies are classified as “borderline sticky.” If half of the food bodies fall apart in under over 2.5 minutes, the food bodies are classified as “sticky.”

Adhesion properties were quantified by TAXT texture analysis and an angle of repose device. TAXT texture analysis involves applying a force to a food bodies and measuring the force of adhesion between a stainless steel plate and a 25 g sample of food bodies. An angle of repose device measures the ability of food bodies to stick to stainless steel. As the angle decreases, stickiness of food bodies decreases. Skilled practitioners will appreciate that other methods can be used to measure cohesion and adhesion.

### Example 3

Various flow agents were tested for reducing cohesion and adhesion of sweetened dried cranberries, including presscake powder (Ocean Spray Cranberries, Inc.), microcrystalline cellulose (Avicell GP1030, FMC Biopolymer), starch (redried starch, Tate and Lyle), rice bran fiber (defatted) (DRB-DF 300, Nutracea), tri-calcium phosphate (Tri-Calcium Anhydrous 3166, DMH Ingredients) , calcium silicate (Hubersorb 600, Huber), and mono/di-glycerides (BFP 74K, Caravan Ingredients).

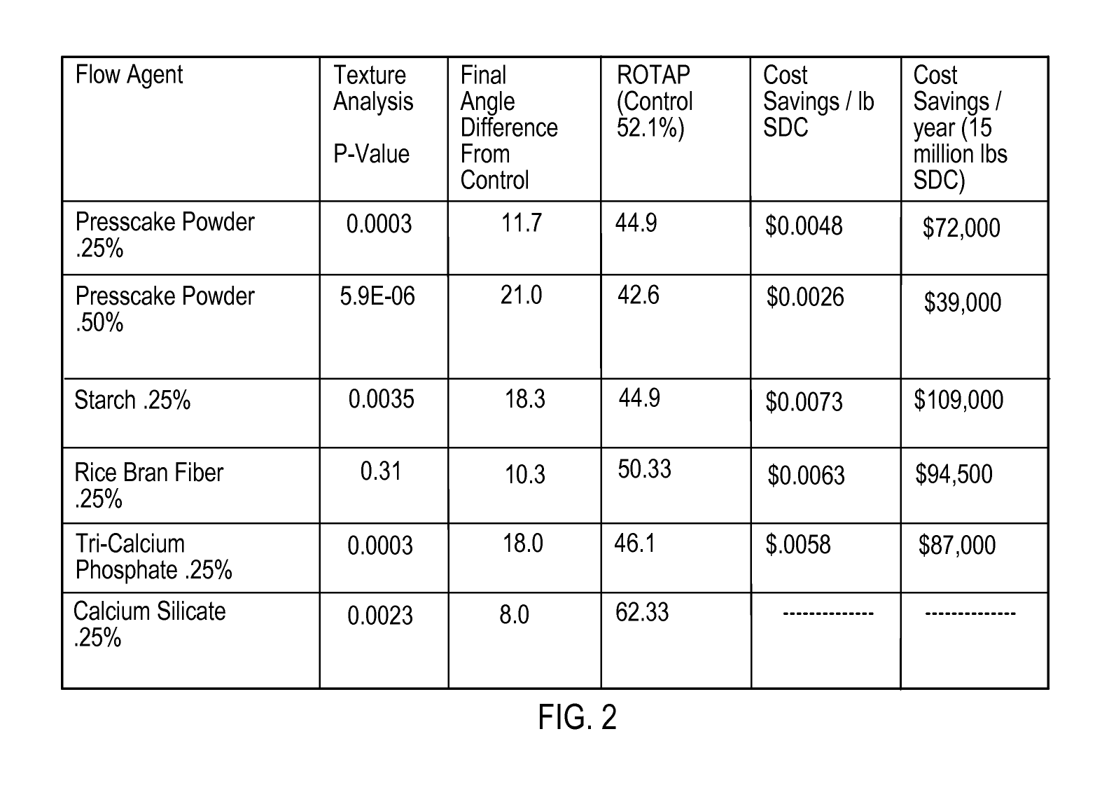

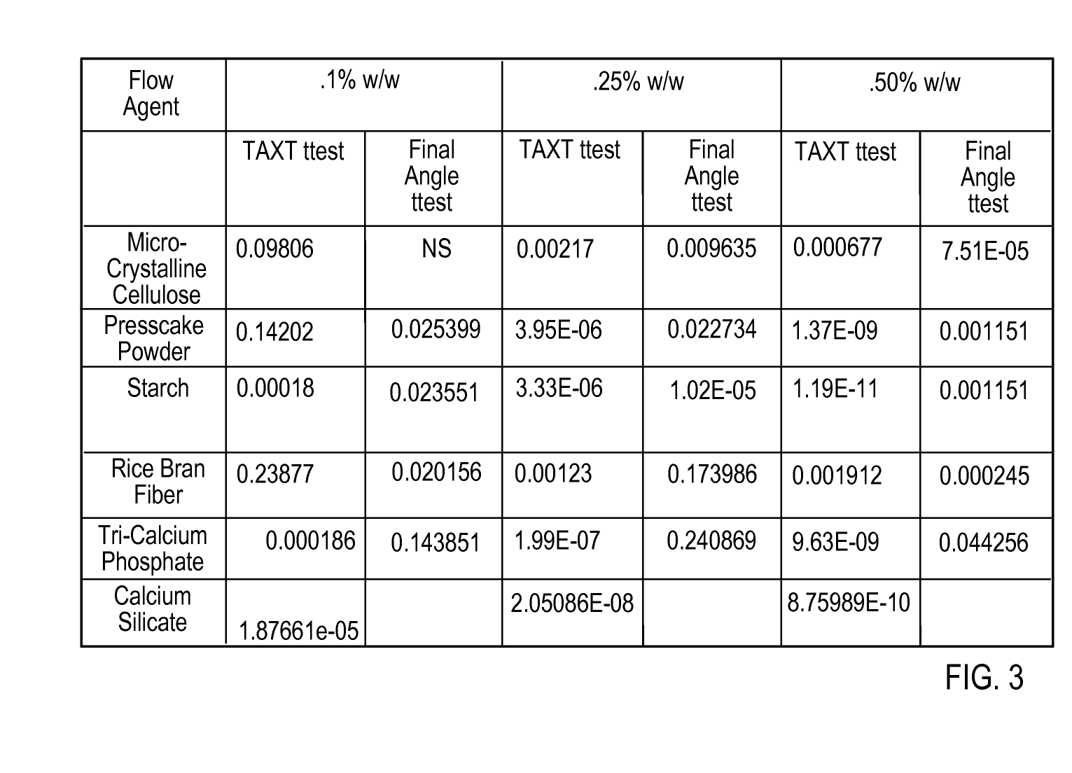

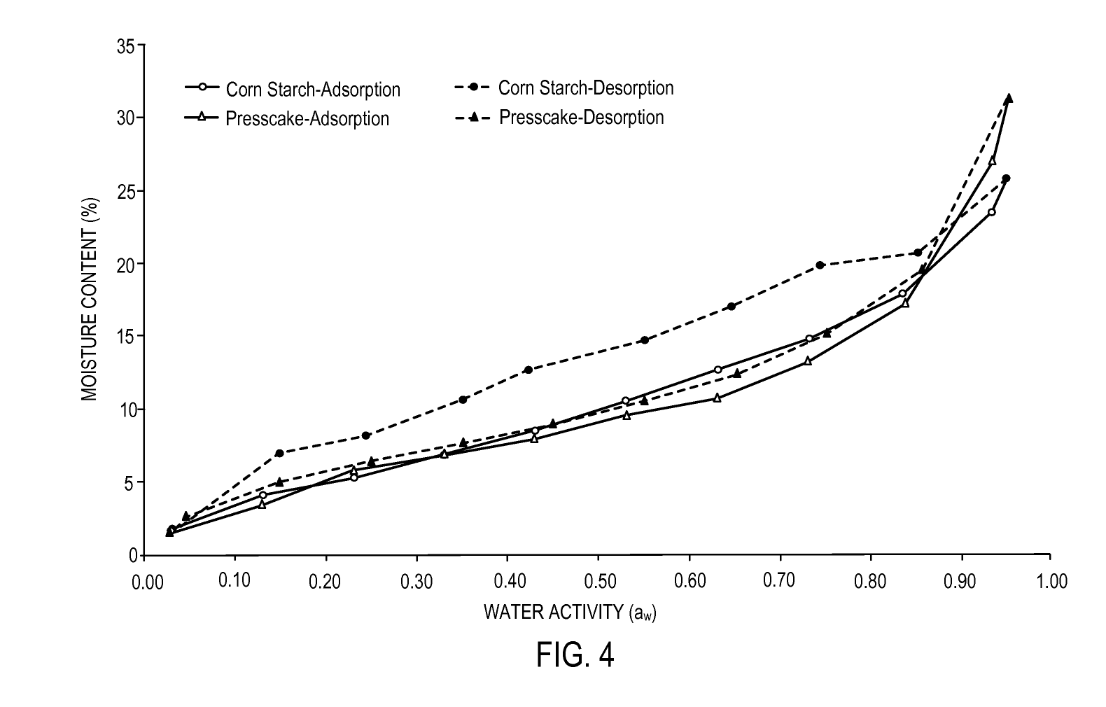

As shown in FIGS. 2 and 3, presscake powder accounting for 0.25% or 0.5% of the total food body by weight performed superior to the other tested flow agents.

### Example 4

The relationship between water activity and moisture content at a given temperature is called the moisture sorption isotherm. Moisture sorption isotherms are valuable for predicting shelf life of a food product and for determining packaging requirements depending on the product's sensitivity to moisture gain or loss. An increase in water activity is almost always accompanied by an increase in the water content, but in a nonlinear fashion.

Moisture sorption isotherms of corn starch and presscake powder were determined using an Aqua Lab Vapor Sorption Analyzer (VSA), Decagon Devices, Inc., Pullman, Wash. Dynamic Vapor Sorption (DVS) option was used. Isotherms were constructed at 20° C. with a range of water activity between 0.03 and 0.95. The relative humidity step was set at 0.1% and it was assumed that the equilibrium water activity was attained when the change in three consecutive sample weight readings were less than 0.1%. As shown in FIG. 4, corn starch was found to have a large hysteresis and followed a Type II-like sorption isotherm. Presscake powder on the other hand showed very little hysteresis and followed closer to a Type III sorption isotherm (FIG. 4). Therefore, fluctuations in water activity of the coated materials will result in more moisture migration in and out of corn starch than migration in and out of presscake powder. As a result, flow properties of presscake powder are less altered during storage with temperature and relative humidity fluctuations than its corn starch counterpart.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A product, the product comprising:
a food body substantially coated with a flow agent comprising particles that are on average less than one millimeter in size, wherein the flow agent has a moisture content of about or less than 10%, and wherein the flow agent accounts for about 0.1% to about 2% of the total food body by weight.

2-5. (canceled)

6. The product of claim 1, wherein the food body is a fruit body.

7. (canceled)

8. The product of claim 1, wherein the flow agent is produced from a fruit.

9. The product of claim 1, wherein the flow agent is produced from a vegetable.

10-11. (canceled)

12. The product of claim 1, wherein the food body is a cranberry.

13-14. (canceled)

15. The product of claim 1, wherein the flow agent is produced from a cranberry.

16. The product of claim 1, wherein the flow agent is cranberry presscake powder.

17. A method of providing a food body substantially coated with a flow agent, the method comprising:
providing a food body; and
applying a flow agent to substantially coat the food body, wherein the flow agent comprises particles that are on average less than one millimeter in size, wherein the flow agent has a moisture content of about or less than 10%, and wherein the flow agent accounts for about 0.1% to about 2% of the total food body by weight.

18-21. (canceled)

22. The method of claim 17, wherein the food body is a fruit body.

23. (canceled)

24. The method of claim 17, wherein the flow agent is produced from a fruit.

25. The method of claim 17, wherein the flow agent is produced from a vegetable.

26-27. (canceled)

28. The method of claim 17, wherein the food body is a cranberry.

29. (canceled)

30. The method of claim 17, wherein the flow agent is produced from a cranberry.

31. The method of claim 17, wherein the flow agent is cranberry presscake powder.

32. The method of claim 17, the method further comprising packaging the food body substantially coated with a flow agent in a container.

33. A flow agent comprising particles that are on average less than one millimeter in size and have a moisture content of about or less than 10%.

34-36. (canceled)

37. The flow agent of claim 33, wherein the flow agent is produced from a fruit.

38. The flow agent of claim 33, wherein the flow agent is produced from a vegetable.

39. The flow agent of claim 33, wherein the flow agent is produced from a cranberry.

40. The flow agent of claim 33, wherein the flow agent is cranberry presscake powder.
